(19) United States
(12) Patent Application Publication
(10) Pub. No.: US 2007/0063468 A1
(43) Pub. Date: Mar. 22, 2007

(54) Dolly for recycle and trash containers

(76) Inventor: Mervin W. Hurtgam, Amherst, NY (US)

Correspondence Address: Wallace F. Neyerlin, Esquire, 726 Division Ave., Niagara Falls, NY, 14305, US

(21) Appl. No.: 11/515,452

(22) Filed: Sep. 5, 2006

Related U.S. Application Data
(63) Continuation-in-part of application No. 11/229,147, filed on Sep. 19, 2005.

(51) Int. Cl. B62B 1/00

(52) U.S. Cl. 280/47.24

(57) ABSTRACT

A versatile and efficient Dolly is described that is useful for lifting and transporting trash or recycle containers to positions where they are intended to be emptied. The Dollies are adjustable to be connected to containers that may vary widely in their dimensions and connection means. The Dolly eliminates the need to have to lift, carry or lug heavy trash or recycle containers to the curb or other intended site locations.

### BACKGROUND OF THE INVENTION

### Field of the Invention

The invention relates to a device useful for eliminating the need of lifting and/or lugging recycle and trash containers to the points where said containers are to be placed for pickup by the persons or departments employed for these purposes.

### SUMMARY OF THE INVENTION

It is an object of the invention to design a device capable of hooking onto or under borders or rims of recycle or trash containers and to be able to tip such containers onto said device, which has two wheels, so as to be able to easily walk the loaded or burdened device to the place designated for pickup. The tipping of the load onto the device eliminates the need of lifting the load; and the wheeled conveyance of the load eliminates the need of “lugging” the load, which is frequently very heavy, to its desired destination.

Broader aspects of the invention and devices within the scope of same will become clear from a further reading of the specification and claims and consideration of the drawings

### BRIEF DESCRIPTION OF THE DRAWINGS

FIG. 1 is a Front View of one of the Dollies or Carts of this invention;

FIG. 1a is a Side View of the Dolly of FIG. 1;

FIG. 1b is a Section through the Dolly of FIG. 1;

FIG. 2 is a Rear View of the Dolly of FIG. 1;

FIG. 3 is a Section through the Back of the Dolly of FIG. 1;

FIG. 4 is an Enlarged Detail View of an Embedded Hook of Use with the Dolly;

FIG. 4a is an Enlarged Detailed View of an Adjustment Spring used with the Dolly of FIG. 1;

FIG. 5 is a series of views showing the Cart or Dolly of FIG. 1 in motion when used to transport a garbage or trash can;

FIG. 6 s a series of views showing the Cart or Dolly of FIG. 1 when used to transport a Recyclable Container;

FIG. 7 is a Front View of an Alternate Version of a Dolly or Cart of this invention; and

FIG. 8 is a front view of another Alternate Version of a Dolly or Cart of this invention showing that the Cart could be just one single center vertical rail with a handle at the top with a slide which moves up and down the center of the rail and which locks in at different heights. The slide has a hook to lock under or hold the handles of the waste receptacle.

FIG. 8a is a Side View of the Dolly FIG. 8.

FIG. 9 is a Front View of yet another Alternate Version of a Dolly or Cart of this invention wherein the wheel placement differs from the wheel placement of the Dolly of FIG. 8. FIG. 9a is a Side View of the Dolly of FIG. 9; and FIG. 9b is a Rear View of the Dolly of FIG. 9.

### DETAILED DESCRIPTION OF THE DRAWINGS

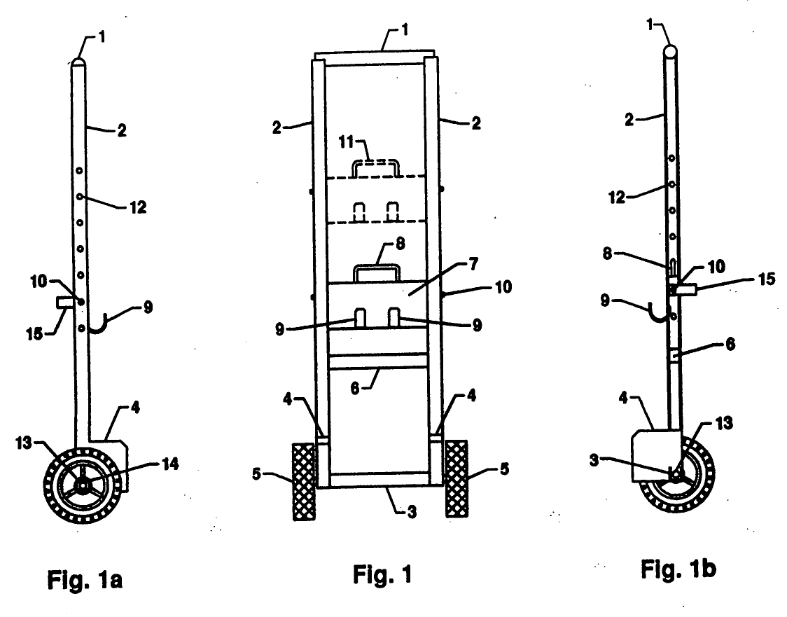

In FIGS. 1, 1a and 1b numeral 1 depicts the top handle, numeral 2 depicts the side channel rails, numeral 3 depicts a bottom channel piece, numeral 4 depicts a side rail extension section (which keeps the container being lifted and transported from hitting the wheels), numeral 5 depicts the wheels of the dolly, numeral 6 depicts a stationary mid-channel rail, numeral 7 depicts a movable connection panel, numeral 8 depicts a handle used to adjust the slant of the dolly, numeral 9 depicts connection hooks for hooking to or under the recycle or trash containers, (or lips of same), numeral 10 depicts connection pins (for adjusting to various size containers), numeral 11 (dotted lines) depicts the connection panel at a different height.

In FIGS. 1a and 1b, numeral 12 depicts numerous holes in the side channels to accept connection pins 10 at desired varied heights; numeral 13 designates axle rods for the wheels 5 and numeral 14 designates cotter pins to hold the wheels in place.

In FIG. 1b numeral 15 designates an adjustment lever for varying the height position of the movable connection panel 7.

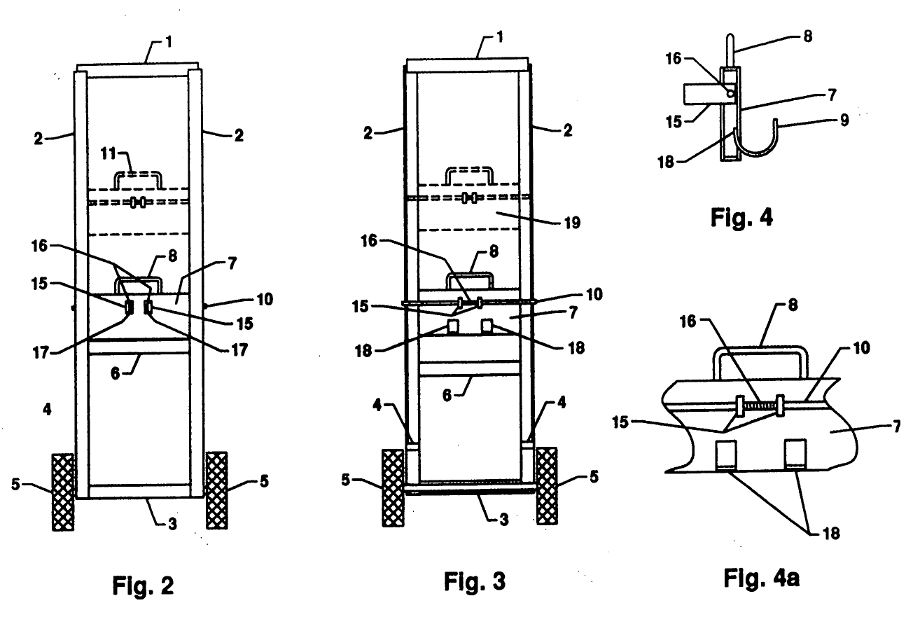

In FIG. 2, numeral 7 designates the back of the adjustment panel in a stationary position, numeral 16 designates springs for adjusting the height location of the panel 10 and numeral 17 designates openings in the back of the adjustment panel for access to adjustment lever 15.

In FIGS. 3, 4 and 4a, numeral 7 designates the front of the adjustment panel in one of its stationary positions, numeral 18 designates embedded portions of connection hooks 9 and numeral 19 designates the spring-compressed adjustment panel in one of its movable positions (dotted lines). As previously indicated FIG. 4a is an enlarged spring detail view.

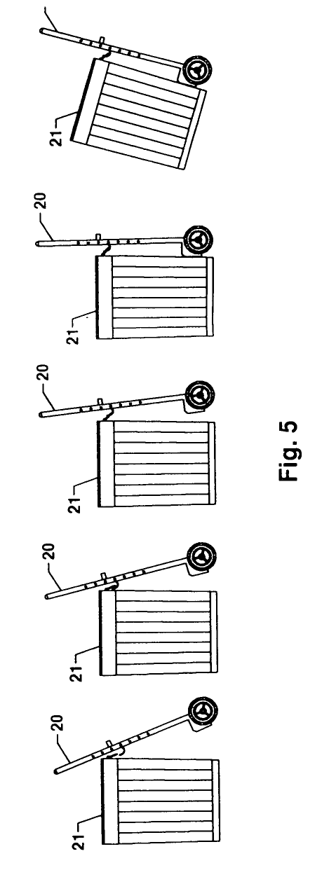

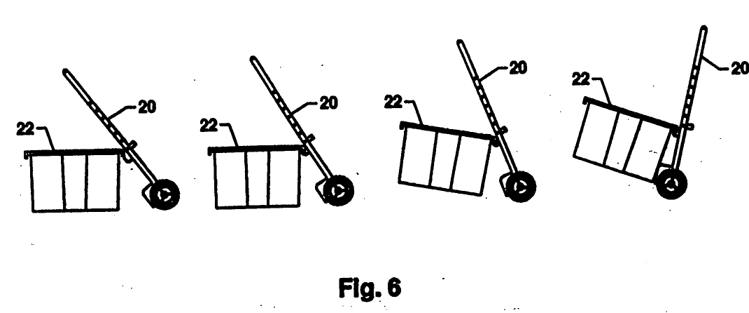

FIG. 5 schematically depicts the operation of the Dolly or Cart, numeral 20 depicting the cart and numeral 21 depicting a garbage can, the sequence showing from left to right the hooking-up of the cart with a garbage can, the next 3 showing the gradual lifting and straightening up of the cart or dolly and the last view on the right showing the tilting of the cart and load in order to wheel the loaded garbage can to its designated place for pickup.

FIG. 6 schematically depicts the operation of the Dolly or Cart, numeral 20 depicting the cart and numeral 22 depicting a container for recycle product, the sequence showing from left to right the hooking-up of the cart with a container for recycle product, the next two showing the gradual lifting and straightening up of the cart or dolly, and the last view on the right showing the tilting of the cart and load in order to wheel the loaded recycle container to its designated place for pickup.

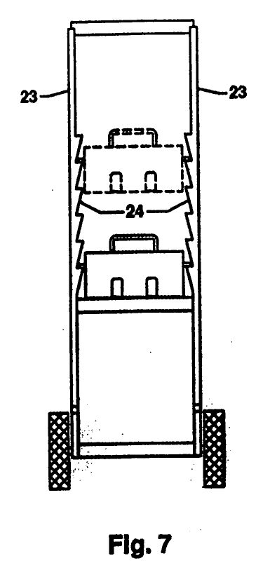

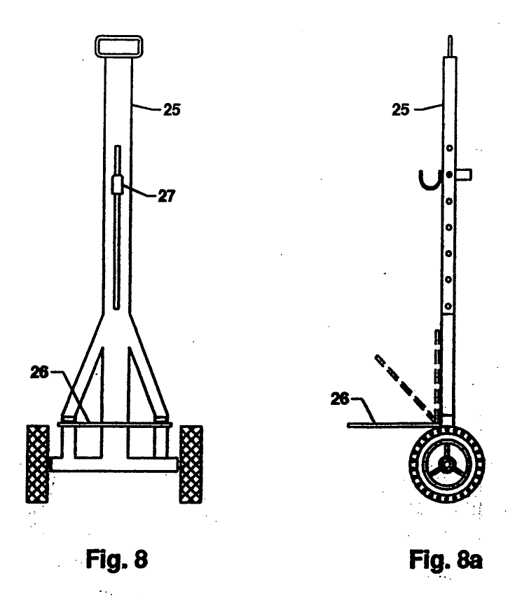

FIG. 7 is a depiction of a Dolly of alternate construction, numeral 23 depicting a side rail of alternate construction and numeral 24 depicting height adjuster means for varying the height of the movable connection panel.

In FIG. 8 numeral 25 depicts a single center vertical rail, (showing that the Cart does not require two side rails), numeral 26 depicts a hinged bottom plate to support the trash or recycle containers, and numeral 27 depicts the slide which moves up and down the rail and which locks in at different heights. The slide has a hook on it for attachment to the waste receptacle.

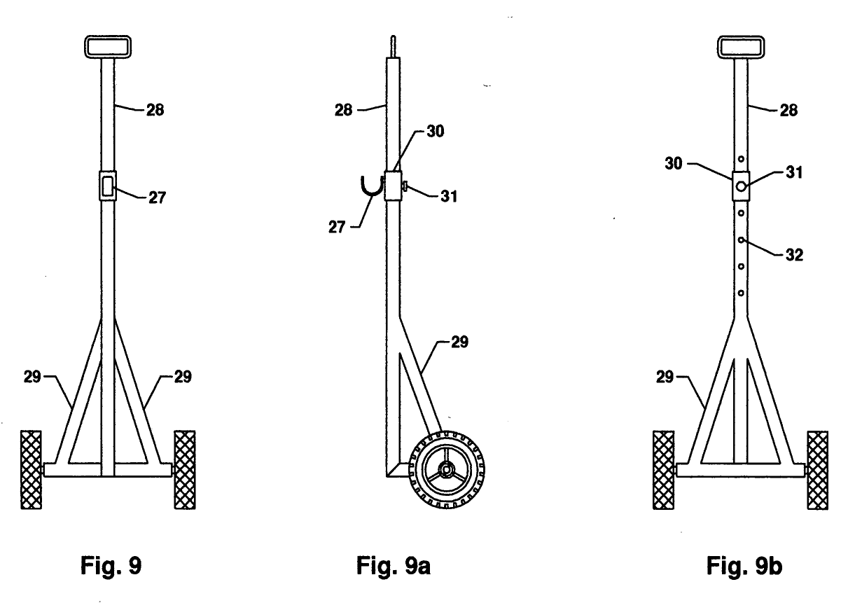

In FIG. 9 numeral 28 depicts the single shaft of the Dolly which shaft may be multi-shaped such as square or tubular; numeral 29 depicts bracing for providing ample strength for the Dolly. In FIGS. 9a and 9b numeral 30 depicts adjustable height slide and numeral 31 depicts pins for locking in holes 32, which holes vary in height vertically within the shaft 28. As shown in FIG. 9a the wheels are in a position to the rear of the shaft, and in this position whatever one picks up rests against the frame or the shaft, and does not interfere with movement of the wheels.

### Preferred Dimensions and Materials of Construction

The Dolly is preferably about 3 feet high from the top of the handle 1 to the bottom of its wheels 5; and about 8 or 9 inches between the inside of the wheels. The thickness of the side channel rails is typically about 1½ inches.

Preferred structural materials for the dolly are plastic, fiberglass, wood or metal. The wheels are preferably rubber or plastic and the axles of the wheels are preferably steel or aluminum.

### Potential Commercial Usage of the Dolly or Cart

The Dolly eliminates the need to have to lift, carry or lug heavy trash or recycle containers to the curb or other intended site location; and is efficiently usable by anyone who owns a house or rents an apartment unit or operates a business that has to get rid of trash or recycle material.

While the present invention has been described and illustrated in detail, various modifications may be made by those skilled in the art. It is therefore to be understood that the invention is not to be limited to the details of construction described and illustrated and it is intended by the appended claims to cover all modifications which fall within the spirit and scope of the invention.

I claim:

1. A dolly for lifting and transporting loaded recycle or trash containers, said dolly comprising:
a. a handle at its top;
b. two substantially parallel side channel rails;
c. two parallel wheels, each at the outside of the side channel rails and connected to said rails at the bottom of the dolly;
d. a movable connection panel between the insides of the side channel rails;
e. a stationary mid-channel rail between the side channel rails positioned toward the bottom of the dolly;
f. an adjustment lever connected to the movable connection panel by means of a connection pin connected to the movable panel for varying the height position of the movable connection panel; and
g. connection hooks attached to the movable connection panel providing a means for attachment or engagement with the recycle or trash container.

2. A dolly according to claim 1 when having side rail extensions at the bases of the side rails, said extensions preventing the loaded recycle or trash containers from contacting the wheels of the dolly.

3. A dolly according to claim 1 when having a handle connected to the movable connection panel thus providing a convenient centralized moment for efficiently tilting the loaded container onto the front face of the dolly.

4. A dolly according to claim 1 wherein the side panels have spaced holes in same providing for variable height locations of the movable connection panel by means of connection pins attached to the movable panel.

5. A dolly according to claim 4 wherein the height locations of the connection pins are controlled by a spring compressed adjustment lever.

6. A dolly according to claim 5 wherein the side panels do not have spaced holes therein but rather spaced inner zigzag ledges providing as a means for variably controlling the alternative height location for the movable connection panel.

7. A dolly according to claim 1 wherein the dolly is about 36 inches high and about 9 inches wide.

8. A dolly for lifting and transporting loaded recycle or trash containers, said dolly comprising;
a. a handle at its top;
b. a single center vertical rail; with a height adjustable slide with a hook attached thereto for engagement with the recycle or trash container; and
c. two parallel wheels, each at the outside of the rail and connected to said rail at the bottom of the dolly.

9. A dolly according to claim 8 when having a hinged bottom plate at the base of the rail, said plate preventing the loaded recycle or trash containers from contacting the wheels of the dolly.

10. A dolly according to claim 8 wherein the center vertical rail has spaced holes in same providing for variable height locations of the adjustable slide by means of connection pins attached to the adjustable slide

11. A dolly according to claim 8 wherein the dolly is about 36 inches high and center vertical rail is about 4 inches wide

12. A dolly for lifting and transporting loaded recycle or trash containers, said dolly comprising;
a. a handle at its top;
b. a single center vertical rail; with a height adjustable slide with a hook attached thereto for engagement with the recycle or trash container; and
c. two parallel wheels, each at the outside and to the rear of the rail and connected to bracing of said rail at the bottom of the dolly.

13. A dolly according to claim 12 wherein the center vertical rail is multi-shaped and has spaced holes in same providing for variable height locations of the adjustable slide by means of connection pins attached to the adjustable slide

14. A dolly according to claim 13 wherein the dolly is about 36 inches high.
